(19) United States
(12) Patent Application Publication
(10) Pub. No.: US 2026/0080135 A1
(43) Pub. Date: Mar. 19, 2026

(54) DUCTED PROPELLER DESIGN METHOD

(71) Applicant: Vincent Loccisano, Wellesley, MA (US)

(72) Inventor: Vincent Loccisano, Wellesley, MA (US)

(21) Appl. No.: 19/341,995

(22) Filed: Sep. 26, 2025

Related U.S. Application Data
(63) Continuation-in-part of application No. 18/629,574, filed on Apr. 8, 2024.

(51) Int. Cl. G06F 30/28; G06F 30/15; G06F 119/14

(52) U.S. Cl. CPC G06F 30/28; G06F 30/15; G06F 2119/14

(57) ABSTRACT

In a method for designing the duct and propeller of a ducted fluid propeller, an example embodiment is a ducted fluid-propeller system with a propeller coupled with an electrical generator, the propeller surrounded by at least one annular airfoil (duct). A method for designing a duct and propeller involves calculating 2D CFD of duct-airfoil coordinates and calculating 3D CFD of duct-airfoil and propeller models, as well as calculating 3D CFD actuator-disk duct and propeller-model designs. The method also involves creating scaled duct models along with modified propeller models for scale-model testing and for creating full-scale duct and propeller models and validating full-scale duct and propeller designs.

### TECHNICAL FIELD

The present disclosure relates to ducted fluid propellers and a method of designing duct and propeller aerodynamic forms.

### BACKGROUND

A ducted propeller or ducted propeller is a fluid propeller that is surrounded by an annular duct, duct, diffuser, or cowling. A ducted propeller significantly enhances thrust compared to an open propeller of the same size. This improvement stems from the duct's ability to manipulate airflow and minimize energy losses due to tip vortices. Ducted propellers are particularly effective for applications requiring high static thrust and efficiency at lower speeds such as vertical takeoff and landing aircraft, drones and marine thrusters.

The core principle behind the increased thrust lies in the duct's interaction with the air flowing through and around the propeller. By enclosing the propeller the duct prevents the tendency of high-pressure air on the downstream side of the propeller blades from swirling around the tips to the low-pressure side. This phenomenon is known as tip vortices and is a source of energy loss and reduced efficiency in open propellers. The close proximity of the duct wall to the blade tips effectively suppresses the formation of tip vortices.

An annular airfoil is a duct with an airfoil cross section. As air is drawn into the duct by the propeller, the inlet, or leading edge of the airfoil, accelerates the incoming flow. According to Bernoulli's principle, this increase in velocity results in a decrease in pressure at the duct leading edge. The low-pressure area creates a forward suction force, effectively pulling the entire assembly upward contributing directly to the total thrust output from the propeller.

A duct funnels greater mass flow through the propeller plane relative to an open propeller of the same diameter. This increased mass flow is an important factor in thrust generation as thrust is a product of the mass of air moved and the velocity at which it is accelerated. The duct essentially allows the propeller to act on a larger column of air.

A ducted propeller provides a propulsion system that can generate significantly more static thrust than a conventional propeller making it a highly effective solution for a variety of applications.

### SUMMARY

The present disclosure generally relates to a method of design of the aerodynamic components of a duct in a ducted propeller. In an example embodiment, a ducted propeller system has a propeller that is surrounded by an annular airfoil or duct.

A ducted propeller duct-design method includes, in combination, 2D Computer Fluid Design (CFD), 3D CFD, Finite-Element Analysis (FEA), scale-model testing and validation, and full-scale testing and validation. Validation gauges the quality of each stage of development while providing information for improving the process.

The method applies to a propeller system disclosed. The propeller has a propeller assembly; an annular duct with annular leading edge; an annular trailing edge; an inner surface extending between the leading edge and the trailing edge; and an outer surface extending between the leading edge and the trailing edge, arranged on a common central axis. The inner surface of the annular duct is in fluid communication with the propeller assembly.

The propeller may also include another annular duct having a leading edge; a trailing edge; an inner surface extending between the leading edge and the trailing edge; and an outer surface extending between the leading edge and the trailing edge, arranged on a common central axis. The inner surface of this annular duct is in fluid communication with the outer surface of the other annular duct. In both annular ducts, the airfoil cross section is oriented such that the inner surface is a lift surface and the outer surface is a pressure surface.

In an aspect of the embodiment, a design-support program has an initial stage for designing an annular duct involving two-dimensional computer fluid design (2D-CFD) to develop two-dimensional geometry for an axis-symmetric duct design. 2D CFD involves scaling airfoil cross-section geometry and varying relative placement and angle of attack of airfoil geometry. Following the scaling process, chord lengths and surface thicknesses are recorded. Another embodiment of the initial stage of the method for designing an annular duct involves a data spreadsheet consisting of duct geometry coordinates. The data spreadsheet is employed to parameterize driving dimensions including flow area, flow angles of attack, duct-airfoil chord lengths and duct-airfoil thicknesses. Further, airfoil contours may be varied along with the parameters to assess the effect on performance and drag. The result is an axis-symmetric form called “duct definition.”

In another aspect of the embodiment, a design-support program involves developing a computer-modeled mesh form based on the duct definition in preparation for a CFD study. Power extraction at the propeller plane is simulated by an actuator disk boundary condition applied to the CFD model. Various pressure-drop profiles may be created for the actuator disk boundary condition, representing various levels of power extraction. Results from this initial CFD study provide initial estimates of power generation from the designed system. Although the system measurements are based on an axial fluid-stream flow direction, and while assuming zero drag on system components, these assumptions are made for all designs tested so that a candidate design may be chosen appropriately. In this manner, multiple duct designs may be tested and evaluated. Results of the CFD analysis parameters may be tabulated in a spreadsheet and compared in order to study the effects of parameter changes.

In another aspect of the embodiment, a design-support program uses three-dimensional computer fluid design (3D-CFD). A 3D CFD model provides a better understanding of the effects of non-symmetric geometry. For example, a faceted annular airfoil produces different results than a round annular airfoil. Support structures such as struts also affect the aerodynamic performance; 3D CFD will show these differences in the results. A pressure-drop actuator disk represents propeller propulsion and provides measured pressure change at the propeller plane, referred to as cT, and measured velocity of the axial fluid-stream at the propeller plane, referred to as uR. The results provide insight into the separation of flow from aerodynamic surfaces and wake characteristics caused by non-symmetric annular duct features. Other non-symmetric annular duct features include off-axis yaw, flap deployment or faired propeller blades.

In yet another aspect of the embodiment, a design-support program uses validation tests that involve the production of a scale model of the propeller ducts for use in a wind tunnel. Wind-tunnel tests typically exhibit low Reynolds numbers and so it is practical to create propellers designed specifically for a wind-tunnel environment. The design-support program also includes full-scale tests of propeller blade designs.

In yet another aspect of the embodiment, a design-support program uses full-scale prototype testing and correlation with 2D and 3D CFD results to validate the design process and make necessary adjustments to improve the process.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic of an example embodiment depicting a method for designing a ducted fluid propeller system;

FIG. 2 is a front-perspective view of an example propeller of the embodiment;

FIG. 3 is a rear-perspective view of an iteration of an example propeller of the embodiment;

FIG. 4 is a perspective view of a propeller duct and ejector duct segments;

FIG. 5 is a spreadsheet depicting 2D CFD parameters and results;

FIG. 6 is a perspective view of a propeller duct and ejector duct segments depicting significant duct-flow areas, and related spreadsheet data;

FIG. 7 depicts a 3D CFD actuator disk velocity plot;

FIG. 8 is a perspective view of a scaled propeller duct test model.

### DETAILED DESCRIPTION

A design method for aerodynamic forms related to ducted or ducted fluid propellers. A duct-and propeller-design method for developing a coupled aerodynamic system. A method for designing annular airfoils includes two-dimensional computer fluid dynamics (2D CFD) and multiple stages of three-dimensional computer fluid dynamics (3D CFD) to evaluate candidate airfoil designs. In tandem, a method for designing a propeller that is intended to be coupled to the aforementioned duct design employs an actuator disk to evaluate propeller-plane coefficient of pressure, C_{P} and propeller-plane fluid velocity, U_{R}. Final evaluation is achieved in scale-model wind-tunnel testing and full-scale design testing. Results from test models and full-scale final designs validate initial 2D CFD and 3D CFD processes.

The term “propeller” or “propeller assembly” refers to any assembly in which blades are attached to a shaft and able to rotate, allowing for the generation of power or energy from fluid rotating the blades. Example embodiments depict a fixed-blade propeller or a propeller assembly having blades that do not change configuration so as to alter their angle of attack, or pitch. Any type of propeller assembly may be used with the fluid propeller systems (e.g., ducted fluid propeller systems) of the present disclosure, for example a variable-pitch-blade propeller, or a propeller or stator assembly.

As used herein, “duct” or “duct” refers to an airfoil ring having a circular cross section, an oval cross section, or a polygonal cross section, and can have a continuous inner and outer surface free of gaps, or inner and outer surface portions interspaced with gaps, slots or holes.

In certain embodiments, the leading edge of a propeller-duct assembly may be considered the top of the fluid propeller system, and the trailing edge of a propeller-duct assembly or of an ejector duct assembly may be considered the bottom. A first component of the fluid propeller system proximal to the top of the propeller system may be considered “upstream” of a second, “downstream” component, proximal to the bottom of the propeller system.

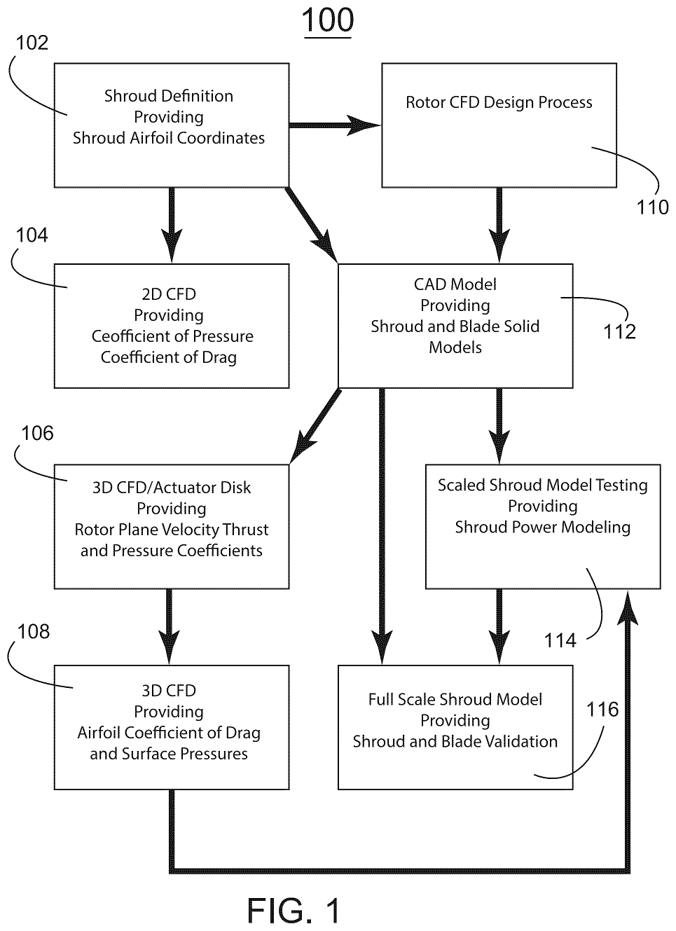

FIG. 1 shows a diagram of the method's steps. A first step 102 includes initial airfoil definition by defining airfoil coordinates. A next step 104 includes two-dimensional computer fluid dynamics (2D CFD), allowing multiple iterations to be evaluated rapidly, and candidate designs chosen without excessive experimentation and trial.

In tandem with the initial design of the duct airfoils, a step 110 includes initial propeller design CFD and a step 112 includes the computer-aided design (CAD) modeling of the initial propeller design and initial duct airfoils, providing propeller blade and duct airfoil 3D solid models.

A following step 106 includes further evaluation of chosen candidate designs, in increasing detail, employing 3D CFD, including a propeller-plane actuator disk to provide estimated propeller plane velocity; U_{R}, propeller-plane thrust coefficient C_{T} and propeller-plane pressure coefficient C_{P}. This step includes information related to the duct CFD as well as the propeller CFD.

A following step 108 includes further evaluation of chosen candidate duct designs, in greater detail, by employing three-dimensional computer fluid dynamics (3D CFD) to determine the duct exit-plane coefficient of pressure (C_{P}) as well as duct geometry coefficient of drag (C_{D}) and surface pressures.

A following step 114 includes a scale model of propeller and ducts. High Reynolds numbers require modified propeller blades for scale model testing in a wind tunnel. Modified propeller design combined with a scaled duct model, used in wind tunnel testing, provides estimated propeller power output or thrust.

A final step 116 involves full-scale testing of the duct-and-propeller combination in a field-tested propeller. Duct and blade validation informs the accuracy of earlier steps, which may then be adjusted for improved outcomes from the design method.

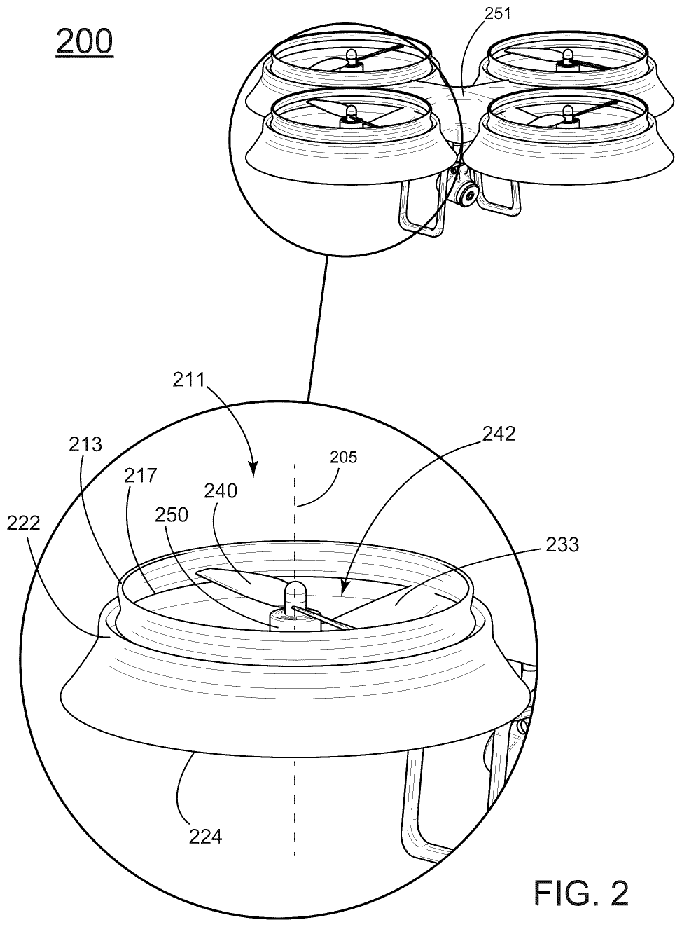

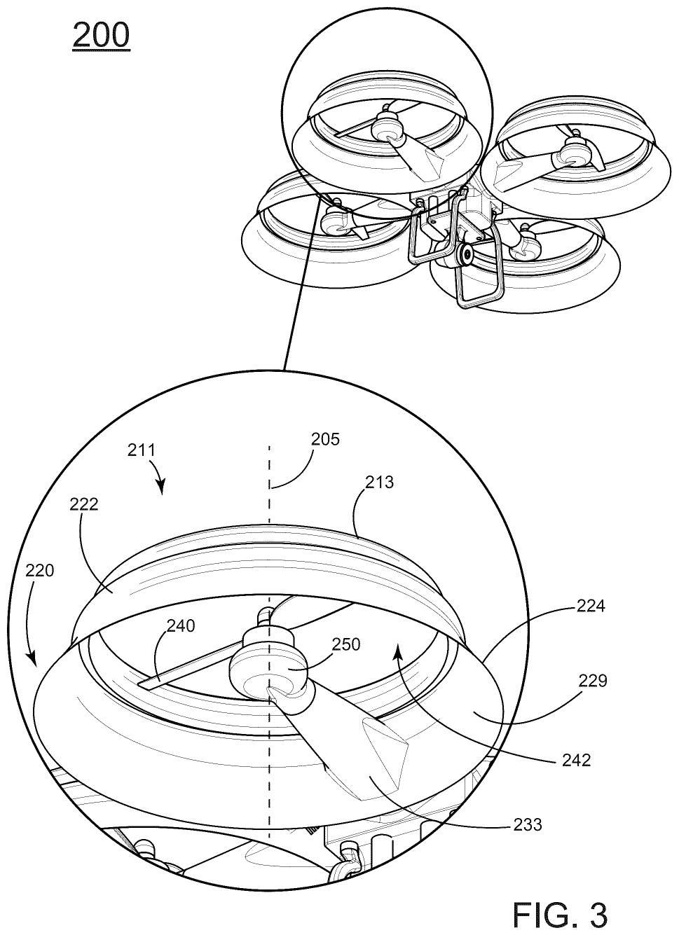

To this end, the embodiment is a method of designing a ducted fluid propeller as shown in FIG. 2 and FIG. 3. The method of design is for an example fluid propeller 200 comprising, as taught herein, a ducted or ducted fluid propeller that includes an annular airfoil 211 (also referred to as a propeller duct), which is in fluid communication with the circumference of a propeller plane 242. The propeller duct comprises a leading edge 213 and a trailing edge 217 and is supported by struts 233. Struts 233 are engaged at the proximal end with the nacelle 250 and at the distal end with the body of an aircraft 251. The propeller duct 211, propeller 240 and nacelle 250 are coaxial about a central axis 205. The structure of the system, as described herein, also allows a duct structure with a propeller duct 211 and an ejector duct 220. The ejector duct 220 is in fluid communication with the exit plane 217 of the propeller duct 211. The ejector duct 220 comprises a leading edge 222 and a trailing edge 224.

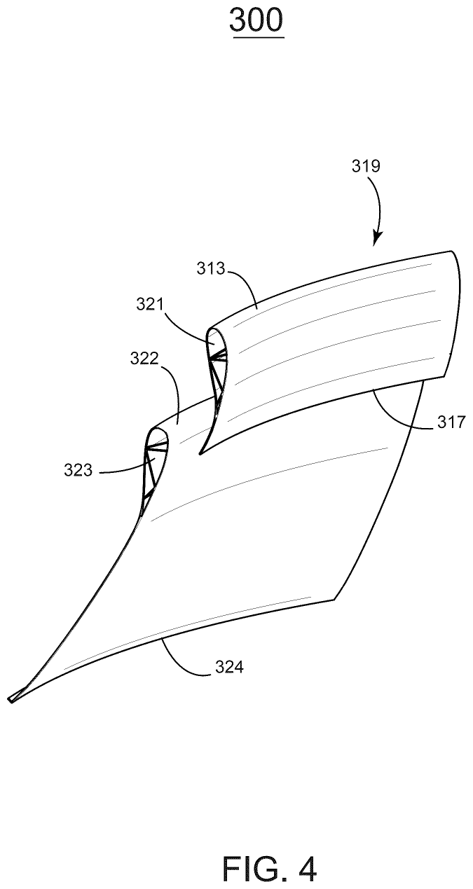

FIG. 4 shows a propeller duct segment 319 and ejector duct segment 329. The propeller duct segment 319 comprises a leading edge 313 and a trailing edge 317 and an airfoil (profiled in cross section 321). The ejector duct segment 329 comprises a leading edge 322, a trailing edge 324 and an airfoil (profiled in cross section 323). The method described herein is applied in the first step 102 (FIG. 1) to duct-airfoil profiles, including propeller-duct airfoil profile 321 (FIG. 4) and ejector-duct airfoil profile 323. Two-dimensional airfoil profiles 321, 323 are used in 2D CFD as previously described and are further employed to generate the 3D geometry that makes up propeller duct segment 319 and ejector duct segment 329.

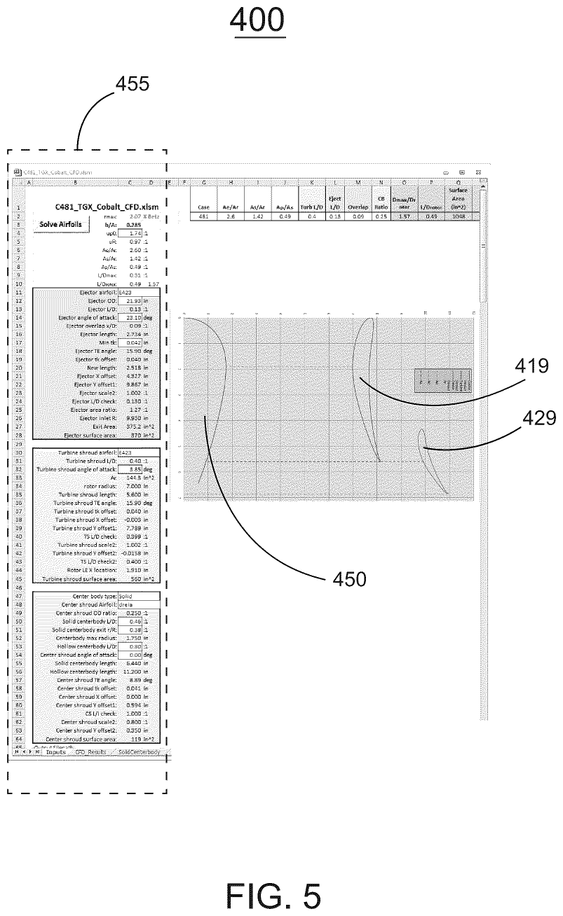

FIG. 5 depicts results from 2D CFD, showing a diagram of a nacelle 450, a propeller duct 419 and an ejector duct 429. Characteristics of duct geometry are displayed in the table in the dashed boundary 455. Important results from the 2D CFD include coefficient of pressure (C_{P}) and duct geometry coefficient of drag (C_{D}).

As understood by one skilled in the art, the aerodynamic principles presented in this disclosure are not restricted to a specific fluid, and may apply to any fluid, including air. The aerodynamic principles of a ducted propeller system in air apply to hydrodynamic principles in a ducted propeller system designed for water.

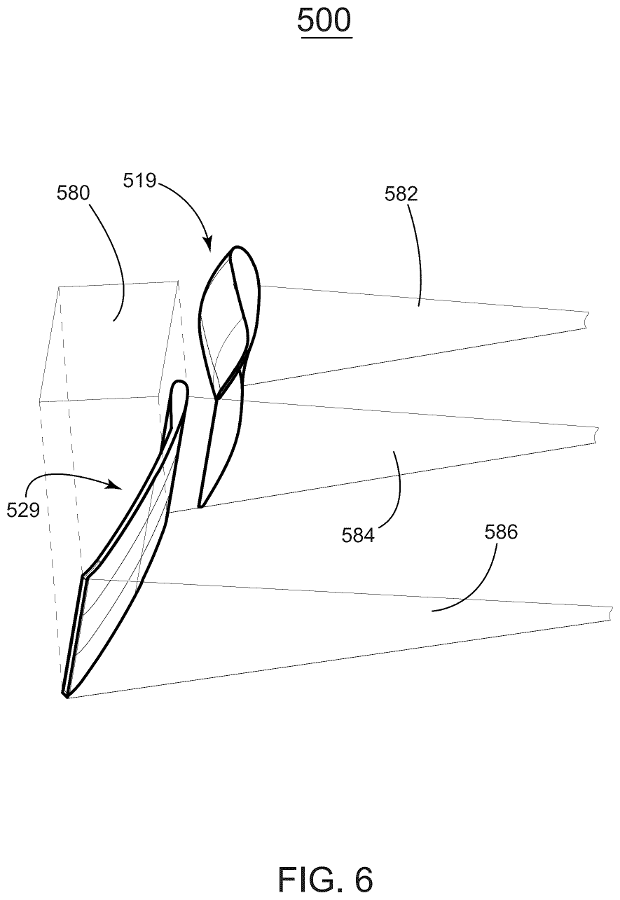

FIG. 6 shows flow areas that are important to the duct design. The ejector-diffusion area 580 relates to the frontal area of the ejector duct 529. The propeller area 582 denotes the propeller plane as it relates to the propeller-duct segment 519. Other important flow areas include the propeller duct 519 exit area 584 and ejector-duct 529 exit area 586.

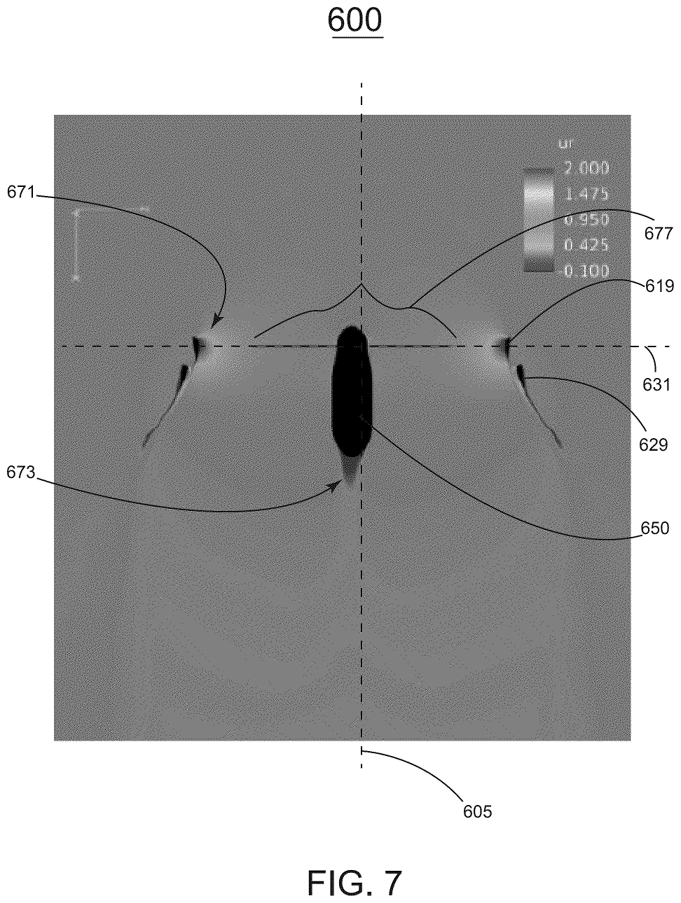

After screening different duct designs with 2D CFD in previous steps, a more detailed 3D CFD model based on the 3D CAD model is developed to better understand effects of non-symmetric geometry, such as a faceted ejector, struts, or propeller support structure. FIG. 7 shows an example velocity plot from a 3D actuator disk CFD model, including propeller-duct segments 619, ejector-duct segments 629 and a nacelle 650; duct segments are symmetrical about the central axis 605. A pressure-drop actuator disk 677 is placed on the propeller plane 631, between the nacelle 650 and the propeller-duct segments 619. Changes in color show variations in fluid-stream velocity, the highest velocity shown in red 671 and the lowest velocity shown in blue 673, indicating separation from the body. The pressure actuator disk 677 is used to represent the propeller power propulsion and provide power, C_{T} (measured pressure change at propeller plane) and U_{R} (velocity at propeller plane) estimates. Study of the post-processing results of the 3D model can give insight to the separation and wakes caused by the periodic and non-symmetric duct features.

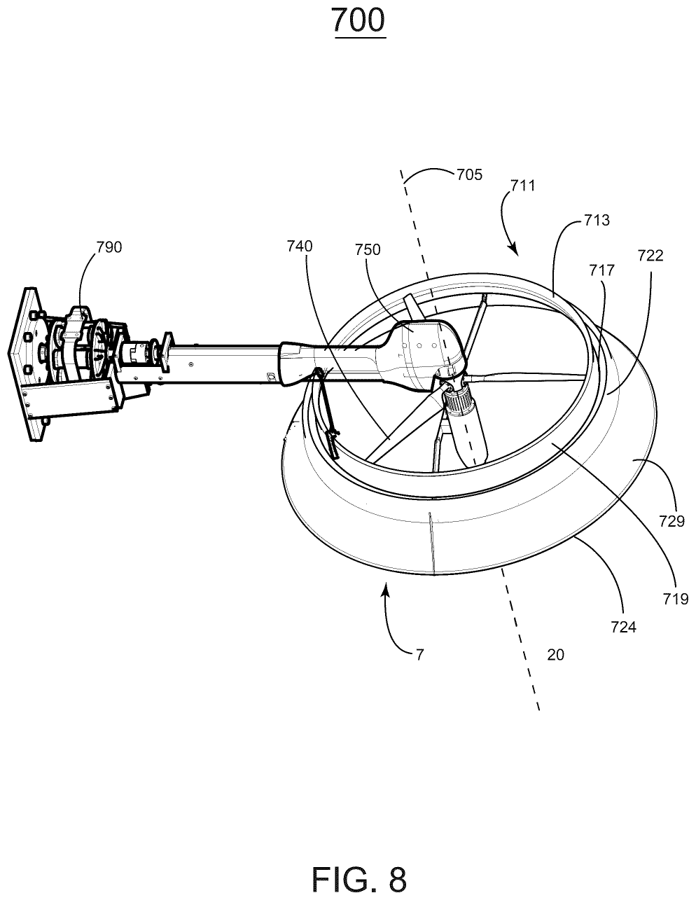

FIG. 8 shows a scale model 700 of a propeller design with a modified propeller and a dynamometer. Wind-tunnel testing of a duct configuration is used to validate the CFD results and predict full-scale performance. A scaled-down test model with a propeller diameter greater than 24″ is built to be tested in a subsonic wind-tunnel with propeller power measured by a torque meter, and loading provided by either a water-current dynamometer or an eddy-current dynamometer.

The scale model 700 comprises a ducted or ducted fluid propeller scale model that includes at least one annular airfoil 711 (referred to as a propeller duct) which is in fluid communication with the circumference of a propeller plane 742. The propeller duct comprises a leading edge 713 and a trailing edge 717. The propeller duct 711, propeller 740 and nacelle 750 are coaxial about a central axis 705. The structure of the system, as described herein, also allows a duct structure including a propeller duct 711 and an ejector duct 720. The ejector duct 720 is in fluid communication with the exit plane 717 of the propeller duct 711. The ejector duct comprises a leading edge 722 and a trailing edge 724. A dynamometer 790 is mechanically engaged with the propeller 740. One skilled in the art understands that engagement between the dynamometer 790 and the propeller 840 may be accomplished by a shaft with a right angle gear inside the nacelle 750, or may be accomplished with various belts and pulleys or other shaft and gear combinations.

1. A method for designing fluid propeller, the method comprising:
providing an annular airfoil surrounding a propeller assembly; and
defining airfoil coordinates for said annular airfoil; and
deriving coefficient of pressure and coefficient of drag from 2D CFD results of said airfoil coordinates; and
defining an annular airfoil coefficient of drag and annular airfoil surface pressures from 3D CFD results; and
designing a 3D CAD model of said annular airfoil coupled with a propeller assembly according to said 2D and 3D CFD results.

2. The method of claim 1 further comprising:
including a 3D CFD actuator disk to define and evaluate propeller plane fluid velocity and propeller plane coefficient of pressure.

3. The method of claim 2 further comprising:
designing a 3D CAD model of a propeller blade of said propeller assembly according to said propeller plane fluid velocity and propeller plane coefficient of pressure.

4. The method of claim 1, 2 or 3 further comprising:
producing a scale model of said fluid propeller for wind tunnel testing.

5. The method of claim 1, 2 or 3 further comprising:
producing a full scale model of said fluid propeller.

6. A method for designing a combination annular-airfoil and a propeller, in a fluid propeller system including a propeller having at least one propeller blade providing a propeller swept-area that is arranged about a central axis, an annular airfoil coaxial with said propeller and surrounding said propeller swept-area, said method comprising:
providing annular-airfoil coordinates that define airfoil cross-sectional area and location of airfoil cross-section with respect to said propeller; and
calculating two-dimensional computer fluid dynamics of said annular-airfoil, determining annular-airfoil coefficient of pressure and coefficient of drag; and
providing a propeller design and an annular-airfoil design in a three-dimensional computer-aided-design model; and
providing an actuator disk denoting coefficient of velocity, coefficient of thrust and coefficient of pressure of said propeller design in said propeller swept-area; and
calculating three-dimensional computer fluid dynamics of said annular-airfoil three-dimensional computer-aided-design and said actuator disk determining coefficient of drag and annular-airfoil surface pressures; and
providing a scaled test-model including a scaled model of said annular-airfoil and a scaled model of said propeller that is modified to account for Reynolds numbers realized in a wind tunnel; and
testing said scaled test-model in said wind tunnel to determine thrust predicted of said annular-airfoil and said propeller in combination; and
providing a full-scale model of said annular-airfoil and said propeller, further providing a motor rotationally engaged with said propeller for producing thrust; and
validating thrust produced by said full scale model, and comparing thrust produced with said thrust predicted; and
modifying said two-dimensional and said three-dimensional computer fluid dynamics to account for discrepancies between said thrust predicted and said thrust produced.

7. A method for designing a combination first annular-airfoil and a second annular-airfoil and a propeller, in a fluid propeller system including a propeller having at least one propeller blade providing a propeller swept-area that is arranged about a central axis, said first annular-airfoil having a leading edge and a trailing edge and being coaxial with said propeller and surrounding said propeller swept-area, said second annular-airfoil having a leading edge and a trailing edge and surrounding said trailing edge of said first annular-airfoil, said method comprising:
providing annular airfoil coordinates that define first annular-airfoil cross-sectional area and second annular-airfoil cross sectional area and location of airfoil cross-sectional areas with respect to each other and with respect to said propeller; and
calculating two-dimensional computer fluid dynamics of said first and second annular-airfoils, determining coefficient of pressure and coefficient of drag of combination of first annular-airfoil and second annular-airfoil; and
providing a propeller design and an annular-airfoil design in a three-dimensional computer-aided-design model; and
providing an actuator disk denoting coefficient of velocity, coefficient of thrust and coefficient of pressure of said propeller design in said propeller swept-area; and
calculating three-dimensional computer fluid dynamics of said annular-airfoil three-dimensional computer-aided-design and said actuator disk determining coefficient of drag and combination first and second annular-airfoil surface pressures: and
providing a scaled test-model including a scaled model of said first and second annular-airfoil and a scaled model of said propeller that is modified to account for Reynolds numbers achieved in a wind tunnel; and
testing said scaled test-model in a wind tunnel to determine thrust predicted of said first and second annular-airfoil and said propeller in combination; and
validating thrust produced by said full scale model, and comparing thrust produced with said thrust predicted; and
modifying said two-dimensional and said three-dimensional computer fluid dynamics to account for discrepancies between said thrust predicted and said thrust produced.
